SEQUENCE LISTING (140 sequences)

SEQ ID NO: 1 - protein, 12 aa, Artificial
  peptide kinase substrate
TEWRSVTLPRDL

SEQ ID NO: 2 - protein, 13 aa, Artificial
  peptide kinase substrate
CNKAFRDTFRLLL

SEQ ID NO: 3 - protein, 13 aa, Artificial
  peptide kinase substrate
KIPKRPGSVHRTP

SEQ ID NO: 4 - protein, 13 aa, Artificial
  peptide kinase substrate
CNATFKKTFRHLL

SEQ ID NO: 5 - protein, 13 aa, Artificial
  peptide kinase substrate
CYALCNRTFRKTF

SEQ ID NO: 6 - protein, 13 aa, Artificial
  peptide kinase substrate
CNRTFRKTFKMLL

SEQ ID NO: 7 - protein, 13 aa, Artificial
  peptide kinase substrate
GSPSKSPSKKKKK

SEQ ID NO: 8 - protein, 13 aa, Artificial
  peptide kinase substrate
KKKFRTPSFLKKS

SEQ ID NO: 9 - protein, 13 aa, Artificial
  peptide kinase substrate
ELLCLRRSSLKAY

SEQ ID NO: 10 - protein, 13 aa, Artificial
  peptide kinase substrate
KDGATMKTFCGTP

SEQ ID NO: 11 - protein, 13 aa, Artificial
  peptide kinase substrate
AGERRKGTDVNVF

SEQ ID NO: 12 - protein, 13 aa, Artificial
  peptide kinase substrate
HSTPPSAYGSVKA

SEQ ID NO: 13 - protein, 13 aa, Artificial
  peptide kinase substrate
VADQTPTPTRFLK

SEQ ID NO: 14 - protein, 13 aa, Artificial
  peptide kinase substrate
ERSKTVTSFYNQS

SEQ ID NO: 15 - protein, 13 aa, Artificial
  peptide kinase substrate
ASLGRRASFHLEC

SEQ ID NO: 16 - protein, 13 aa, Artificial
  peptide kinase substrate
LEDIKRLTPRFTL

SEQ ID NO: 17 - protein, 13 aa, Artificial
  peptide kinase substrate
KTPDGNKSPAPKP

SEQ ID NO: 18 - protein, 13 aa, Artificial
  peptide kinase substrate
INEWLTKTPDGNK

SEQ ID NO: 19 - protein, 13 aa, Artificial
  peptide kinase substrate
EGEEDTEYMTPSS

SEQ ID NO: 20 - protein, 16 aa, Artificial
  peptide kinase substrate
GIPIRVYTHEVVTLWY

SEQ ID NO: 21 - protein, 13 aa, Artificial
  peptide kinase substrate
GSPNRAYTHQVVT

SEQ ID NO: 22 - protein, 14 aa, Artificial
  peptide kinase substrate
MGPRRRSRKPEAPR

SEQ ID NO: 23 - protein, 13 aa, Artificial
  peptide kinase substrate
HHKLVLPSNTPNV

SEQ ID NO: 24 - protein, 13 aa, Artificial
  peptide kinase substrate
NIHLEKKYVRRDS

SEQ ID NO: 25 - protein, 13 aa, Artificial
  peptide kinase substrate
EPLERRLSLVPDS

SEQ ID NO: 26 - protein, 13 aa, Artificial
  peptide kinase substrate
LQARRRQSVLNLM

SEQ ID NO: 27 - protein, 13 aa, Artificial
  peptide kinase substrate
IHRKTTASTRKVS

SEQ ID NO: 28 - protein, 13 aa, Artificial
  peptide kinase substrate
QCALCRRSTTDCG

SEQ ID NO: 29 - protein, 13 aa, Artificial
  peptide kinase substrate
ETSLMRTLCGTPT

SEQ ID NO: 30 - protein, 13 aa, Artificial
  peptide kinase substrate
DMKVRKSSTPEEV

SEQ ID NO: 31 - protein, 13 aa, Artificial
  peptide kinase substrate
EILSRRPSYRKIL

SEQ ID NO: 32 - protein, 13 aa, Artificial
  peptide kinase substrate
ISSVPTPSPLGPL

SEQ ID NO: 33 - protein, 13 aa, Artificial
  peptide kinase substrate
HFDERDKTSRNMR

SEQ ID NO: 34 - protein, 13 aa, Artificial
  peptide kinase substrate
GGPGPERTPGSGS

SEQ ID NO: 35 - protein, 13 aa, Artificial
  peptide kinase substrate
LLPTHTLTPVLLT

SEQ ID NO: 36 - protein, 13 aa, Artificial
  peptide kinase substrate
ISVDGLSTPVVLS

SEQ ID NO: 37 - protein, 13 aa, Artificial
  peptide kinase substrate
LLNKRRGSVPILR

SEQ ID NO: 38 - protein, 13 aa, Artificial
  peptide kinase substrate
QQKIRKYTMRRLL

SEQ ID NO: 39 - protein, 13 aa, Artificial
  peptide kinase substrate
GEAGGPLTPRRVS

SEQ ID NO: 40 - protein, 13 aa, Artificial
  peptide kinase substrate
GGRERLASTNDKG

SEQ ID NO: 41 - protein, 13 aa, Artificial
  peptide kinase substrate
NPLMRRNSVTPLA

SEQ ID NO: 42 - protein, 13 aa, Artificial
  peptide kinase substrate
LNVAAVNTHRDRP

SEQ ID NO: 43 - protein, 13 aa, Artificial
  peptide kinase substrate
EFPSRGKSSSYSK

SEQ ID NO: 44 - protein, 13 aa, Artificial
  peptide kinase substrate
QSRPRSCTWPLQR

SEQ ID NO: 45 - protein, 13 aa, Artificial
  peptide kinase substrate
QSKVPFRSRSPSE

SEQ ID NO: 46 - protein, 13 aa, Artificial
  peptide kinase substrate
PKLGRRHSMENME

SEQ ID NO: 47 - protein, 13 aa, Artificial
  peptide kinase substrate
SRLRRRASQLKIT

SEQ ID NO: 48 - protein, 13 aa, Artificial
  peptide kinase substrate
EKMWAFMSSRQQT

SEQ ID NO: 49 - protein, 13 aa, Artificial
  peptide kinase substrate
FMSSRRQSVLVKS

SEQ ID NO: 50 - protein, 13 aa, Artificial
  peptide kinase substrate
KKPRRKDTPALHI

SEQ ID NO: 51 - protein, 13 aa, Artificial
  peptide kinase substrate
MLRGRSLSVTSLG

SEQ ID NO: 52 - protein, 14 aa, Artificial
  peptide kinase substrate
GKKRKRSRKESYSI

SEQ ID NO: 53 - protein, 13 aa, Artificial
  peptide kinase substrate
DGKKRKRSRKESY

SEQ ID NO: 54 - protein, 16 aa, Artificial
  peptide kinase substrate
RTKQTARKSTGGKAPR

SEQ ID NO: 55 - protein, 13 aa, Artificial
  peptide kinase substrate
KEREKEISDDEAE

SEQ ID NO: 56 - protein, 13 aa, Artificial
  peptide kinase substrate
KKNGRILTLPRSN

SEQ ID NO: 57 - protein, 13 aa, Artificial
  peptide kinase substrate
QIRRRRPTPATLV

SEQ ID NO: 58 - protein, 13 aa, Artificial
  peptide kinase substrate
LEHVTRRTLSMDK

SEQ ID NO: 59 - protein, 13 aa, Artificial
  peptide kinase substrate
SRFNRRVSVCAET

SEQ ID NO: 60 - protein, 13 aa, Artificial
  peptide kinase substrate
NRFTRRASVCAEA

SEQ ID NO: 61 - protein, 15 aa, Artificial
  peptide kinase substrate
VKGRTWTLCGTPEYL

SEQ ID NO: 62 - protein, 13 aa, Artificial
  peptide kinase substrate
DPGSVLSTACGTP

SEQ ID NO: 63 - protein, 12 aa, Artificial
  peptide kinase substrate
VASMMHRQETVE

SEQ ID NO: 64 - protein, 13 aa, Artificial
  peptide kinase substrate
DSDLSRRSSSTMS

SEQ ID NO: 65 - protein, 13 aa, Artificial
  peptide kinase substrate
PDLKKSRSASTIS

SEQ ID NO: 66 - protein, 13 aa, Artificial
  peptide kinase substrate
EELRKARSNSTLS

SEQ ID NO: 67 - protein, 13 aa, Artificial
  peptide kinase substrate
ANRERRPSYLPTP

SEQ ID NO: 68 - protein, 13 aa, Artificial
  peptide kinase substrate
KWTKRTLSETSSS

SEQ ID NO: 69 - protein, 13 aa, Artificial
  peptide kinase substrate
LDIPTGTTPQRKS

SEQ ID NO: 70 - protein, 13 aa, Artificial
  peptide kinase substrate
QVEFRRLSISAES

SEQ ID NO: 71 - protein, 13 aa, Artificial
  peptide kinase substrate
RFARKGSLRQKNV

SEQ ID NO: 72 - protein, 14 aa, Artificial
  peptide kinase substrate
AENFDRFFTRHPPV

SEQ ID NO: 73 - protein, 13 aa, Artificial
  peptide kinase substrate
GKKTKFASDDEHD

SEQ ID NO: 74 - protein, 13 aa, Artificial
  peptide kinase substrate
GGPTTPLSPTRLS

SEQ ID NO: 75 - protein, 13 aa, Artificial
  peptide kinase substrate
DAENRLQTMKEEL

SEQ ID NO: 76 - protein, 13 aa, Artificial
  peptide kinase substrate
KKKKKRFSFKKSF

SEQ ID NO: 77 - protein, 13 aa, Artificial
  peptide kinase substrate
FKKSFKLSGFSFK

SEQ ID NO: 78 - protein, 13 aa, Artificial
  peptide kinase substrate
HFFKNIVTPRTPP

SEQ ID NO: 79 - protein, 13 aa, Artificial
  peptide kinase substrate
KNIVTPRTPPPSQ

SEQ ID NO: 80 - protein, 13 aa, Artificial
  peptide kinase substrate
AGTSFMMTPYVVT

SEQ ID NO: 81 - protein, 13 aa, Artificial
  peptide kinase substrate
GDAAETPPRPRTP

SEQ ID NO: 82 - protein, 13 aa, Artificial
  peptide kinase substrate
PPRPRTPGRPLSS

SEQ ID NO: 83 - protein, 13 aa, Artificial
  peptide kinase substrate
EDENGDITPIKAK

SEQ ID NO: 84 - protein, 13 aa, Artificial
  peptide kinase substrate
RSGLYRSPSMPEN

SEQ ID NO: 85 - protein, 13 aa, Artificial
  peptide kinase substrate
DNTPHTPTPFKNA

SEQ ID NO: 86 - protein, 13 aa, Artificial
  peptide kinase substrate
KKFELLPTPPLSP

SEQ ID NO: 87 - protein, 13 aa, Artificial
  peptide kinase substrate
LSAFRRTSLAGGG

SEQ ID NO: 88 - protein, 13 aa, Artificial
  peptide kinase substrate
RGAPPRRSSIRNA

SEQ ID NO: 89 - protein, 13 aa, Artificial
  peptide kinase substrate
QDAYRRNSVRFLQ

SEQ ID NO: 90 - protein, 13 aa, Artificial
  peptide kinase substrate
DLILNRCSESTKR

SEQ ID NO: 91 - protein, 13 aa, Artificial
  peptide kinase substrate
FAKTFVGTPYYMS

SEQ ID NO: 92 - protein, 13 aa, Artificial
  peptide kinase substrate
FACTYVGTPYYVP

SEQ ID NO: 93 - protein, 13 aa, Artificial
  peptide kinase substrate
FVQLRRKSDLETS

SEQ ID NO: 94 - protein, 13 aa, Artificial
  peptide kinase substrate
SFKRRRSSKDTST

SEQ ID NO: 95 - protein, 13 aa, Artificial
  peptide kinase substrate
GRRGRLPSKPKQP

SEQ ID NO: 96 - protein, 13 aa, Artificial
  peptide kinase substrate
LHALGKATPIYLD

SEQ ID NO: 97 - protein, 13 aa, Artificial
  peptide kinase substrate
EPHVTRRTPDYFL

SEQ ID NO: 98 - protein, 16 aa, Artificial
  peptide kinase substrate
LPNNTSSSPQPKKKPL

SEQ ID NO: 99 - protein, 13 aa, Artificial
  peptide kinase substrate
GTPTRKISASEFD

SEQ ID NO: 100 - protein, 13 aa, Artificial
  peptide kinase substrate
QEKRRQISIRGIV

SEQ ID NO: 101 - protein, 13 aa, Artificial
  peptide kinase substrate
RSGSRRGSFDATG

SEQ ID NO: 102 - protein, 13 aa, Artificial
  peptide kinase substrate
GQKFARKSTRRSI

SEQ ID NO: 103 - protein, 13 aa, Artificial
  peptide kinase substrate
EEGTFRSSIRRLS

SEQ ID NO: 104 - protein, 13 aa, Artificial
  peptide kinase substrate
RSAIRRASTIEMP

SEQ ID NO: 105 - protein, 13 aa, Artificial
  peptide kinase substrate
EQRMKESSFYSLC

SEQ ID NO: 106 - protein, 13 aa, Artificial
  peptide kinase substrate
ALRERLSSFTSYE

SEQ ID NO: 107 - protein, 13 aa, Artificial
  peptide kinase substrate
FMRLRRLSTKYRT

SEQ ID NO: 108 - protein, 15 aa, Artificial
  peptide kinase substrate
GLRRWSLGGLRRWSL

SEQ ID NO: 109 - protein, 14 aa, Artificial
  peptide kinase substrate
EGLRSRSTRMSTVS

SEQ ID NO: 110 - protein, 13 aa, Artificial
  peptide kinase substrate
KSNVKIQSTPVKQ

SEQ ID NO: 111 - protein, 11 aa, Artificial
  peptide kinase substrate
RDKYKTLRQIR

SEQ ID NO: 112 - protein, 13 aa, Artificial
  peptide kinase substrate
SQRQRSTSTPNVH

SEQ ID NO: 113 - protein, 13 aa, Artificial
  peptide kinase substrate
PGKARKKSSCQLL

SEQ ID NO: 114 - protein, 13 aa, Artificial
  peptide kinase substrate
AVIPINGSPRTPR

SEQ ID NO: 115 - protein, 13 aa, Artificial
  peptide kinase substrate
IYISPLKSPYKIS

SEQ ID NO: 116 - protein, 13 aa, Artificial
  peptide kinase substrate
KENSPCVTPVSTA

SEQ ID NO: 117 - protein, 13 aa, Artificial
  peptide kinase substrate
DEICIAGSPLTPR

SEQ ID NO: 118 - protein, 13 aa, Artificial
  peptide kinase substrate
CIAGSPLTPRRVT

SEQ ID NO: 119 - protein, 13 aa, Artificial
  peptide kinase substrate
GLGRSITSPTTLY

SEQ ID NO: 120 - protein, 13 aa, Artificial
  peptide kinase substrate
DSPSDGGTPGRMP

SEQ ID NO: 121 - protein, 13 aa, Artificial
  peptide kinase substrate
ELNKDRTSRDSSP

SEQ ID NO: 122 - protein, 13 aa, Artificial
  peptide kinase substrate
DRTSRDSSPVMRS

SEQ ID NO: 123 - protein, 13 aa, Artificial
  peptide kinase substrate
KMQLRRPSDQEVS

SEQ ID NO: 124 - protein, 13 aa, Artificial
  peptide kinase substrate
IAKRRRLSSLRAS

SEQ ID NO: 125 - protein, 13 aa, Artificial
  peptide kinase substrate
VRRLRRLTAREAA

SEQ ID NO: 126 - protein, 13 aa, Artificial
  peptide kinase substrate
KNGCRRGSSLGQI

SEQ ID NO: 127 - protein, 13 aa, Artificial
  peptide kinase substrate
LIEDNEYTARQGA

SEQ ID NO: 128 - protein, 13 aa, Artificial
  peptide kinase substrate
KTPSSPVYQDAVS

SEQ ID NO: 129 - protein, 13 aa, Artificial
  peptide kinase substrate
SSRRTTLCGTLDY

SEQ ID NO: 130 - protein, 13 aa, Artificial
  peptide kinase substrate
AAGERRKSQEAQV

SEQ ID NO: 131 - protein, 13 aa, Artificial
  peptide kinase substrate
GSRSRTPSLPTPP

SEQ ID NO: 132 - protein, 13 aa, Artificial
  peptide kinase substrate
EPPSPATTPCGKV

SEQ ID NO: 133 - protein, 13 aa, Artificial
  peptide kinase substrate
HQRRKYRSNKGES

SEQ ID NO: 134 - protein, 15 aa, Artificial
  peptide kinase substrate
RFIGRRQSLIEDARK

SEQ ID NO: 135 - protein, 13 aa, Artificial
  peptide kinase substrate
EHIERRVSNAGGP

SEQ ID NO: 136 - protein, 13 aa, Artificial
  peptide kinase substrate
GAKLRKVSKQEEA

SEQ ID NO: 137 - protein, 13 aa, Artificial
  peptide kinase substrate
LARRRKATQVGEK

SEQ ID NO: 138 - protein, 13 aa, Artificial
  peptide kinase substrate
EEKKKKTTTIAVE

SEQ ID NO: 139 - protein, 13 aa, Artificial
  peptide kinase substrate
NQNSRRPSRATWL

SEQ ID NO: 140 - protein, 13 aa, Artificial
  peptide kinase substrate
LGADDSYYTARSA

(19) United States
(12) Patent Application Publication
(10) Pub. No.: US 2011/0071052 A1
(43) Pub. Date: Mar. 24, 2011

(54) MEASUREMENT OF PROTEIN KINASE ACTIVITY IN CEREBROSPINAL FLUID FOR DIAGNOSIS OF NEUROLOGICAL AND PSYCHIATRIC DISORDERS

(76) Inventors: Maria Helena Hilhorst, Wageningen (NL); Richard De Wijn, Nijmegen (NL); Jeroen Joseph Maria Hoozemans, Amsterdam (NL); Saskia Maria Van Der Vies, Amstelveen (NL)

(21) Appl. No.: 12/736,561

(22) PCT Filed: Apr. 24, 2009
(86) PCT No.: PCT/EP2009/054994

§ 371 Date: Nov. 19, 2010

(30) Foreign Application Priority Data
Apr. 25, 2008 (EP) 08155211.9

(51) Int. Cl. C40B 30/08; C40B 40/10; C40B 40/00

(52) U.S. Cl. 506/11; 506/18; 506/13

(57) ABSTRACT

The present invention relates to the use of endogenous protein kinase activity in cerebrospinal fluid for the classification, diagnosis and prognosis of neurological and psychiatric disorders as well as for predicting and monitoring treatment effects. An array of substrates for protein kinases, immobilized on a porous matrix, is used to monitor the protein kinase activity in cerebrospinal fluid. The method of the present invention enables the early diagnosis and discrimination between neurodegenerative disorders.

### FIELD OF THE INVENTION

The present invention relates to the use of cerebrospinal fluid for the classification, diagnosis and prognosis of neurological and psychiatric disorders as well as for predicting and monitoring treatment effects. More specifically it relates to the use of endogenous protein kinase activity in cerebrospinal fluid for the above purpose. In particular an array of substrates for protein kinases, immobilized on a porous matrix, is used to monitor the protein kinase activity in cerebrospinal fluid.

### BACKGROUND

Cerebrospinal fluid (CSF) is a clear bodily fluid that occupies the subarachnoid space and the ventricular system around and inside the brain. More specifically CSF occupies the space between the arachnoid mater and the pia mater. Moreover it constitutes the content of all intra-cerebral ventricles, cisterns and sulci, as well as the central canal of the spinal cord. CSF is an approximately isotonic solution that acts as a buffer for the cortex, providing also a basic mechanical and immunological protection to the brain inside the skull. CSF is usually obtained by a lumbar puncture. The CSF contains approximately 0.3% plasma proteins depending on sampling site.

Different characteristics of CSF, such as the protein, glucose and cellular content, are known to be used in medicine for the diagnosis of a variety of neurological diseases. These parameters alone may be extremely beneficial in the diagnosis of subarachnoid haemorrhage and central nervous system infections, such as meningitis. Using more sophisticated methods for analysis of CSF, e.g. the detection of the oligoclonal bands, an ongoing inflammatory condition, such as multiple sclerosis, can be recognized.

The protein composition of cerebrospinal fluid is largely derived from serum proteins which leak in to the subarachnoid space through imperfections in the blood brain barrier, such as the area postrema, and perhaps across the choroid plexus, the richly vascular structure through which cerebrospinal fluid is generated as an ultrafiltrate. Some proteins, such as immunogloblulins may be generated in the subarachnoid space during inflammation. Since the cerebrospinal fluid bathes the surfaces of cerebral and cerebellar cortices, the caudate, brainstem and spinal cord, some contribution of these structures to total cerebrospinal fluid protein might be expected.

The protein composition of CSF has been reported to change as consequence of certain neurological disorders. It may to a certain extend reflect what is happening in the neurons. The occurrence of certain proteins in CSF has been related to Creutzfeldt-Jakob disease, Schizophrenia and Alzheimer's disease. The presence of single proteins or combinations of proteins obtained through 2D-electrophoresis or ELISA, have been used to classify these disorders.

Signal transduction refers to any process by which a cell converts one kind of signal or stimulus to another and is one of the most important biological processes that is currently under investigation. Signal transduction involves an ordered sequence of biochemical reactions, which are carried out by enzymes that activate secondary messengers. Through this process cells regulate various activities needed for life. The regulation of signal transduction processes involves changes in protein phosphorylation. As many as up to 1000 kinases, more than 500 protein kinases and 500 phosphatases in the human genome are thought to be involved in phosphorylation processes. The targets of phosphorylation encompass a large group of signalling molecules, including enzymes.

It has already been established that protein kinases, both tyrosine, serine and threonine kinases, play an important role in signalling pathways that are known to play key roles in various diseases. However only a limited number of the known protein kinases have been investigated so far. The present invention therefore provides a method for monitoring the activity of protein kinases. The inventors of the present invention have shown that CSF surprisingly contains active protein kinases and that the differences in protein kinase activity can be linked to various neurological and/or psychiatric disorders.

The method of the present invention provides a convenient diagnostic tool to use in the diagnosis of disorders. Many such disorders, especially the neurodegenerative disorders have heretofore been diagnosed by exclusion and were based on clinical criteria supported by neuropsychological tests and neuroimaging. Especially in the early stage of the disorder it is difficult to distinguish different types of dementia, since the clinical symptoms are often subtle. Hence a significant number of diagnoses cannot be made or turn out to be wrong based on analysis of post-mortem brain material. Therefore there is a need for new methods and systems for the diagnosis of neurodegenerative disorders. Therefore, new techniques that enable the diagnosis and discrimination between neurodegenerative disorders are warranted. Obviously, a simpler, less-invasive technique would be a welcome addition to the diagnostic arts. This invention provides such a diagnostic tool which utilizes only a small sample of the patients' cerebrospinal fluid.

### SUMMARY OF THE INVENTION

Cerebrospinal fluid is known in medicine as a source for the diagnosis of a variety of neurological diseases. The present application relates to the use of cerebrospinal fluid (CSF) for the classification, diagnosis, prognosis and prediction of treatment effects. More specifically the inventors have shown that, notwithstanding the low protein content in CSF compared to other bodily fluids, the method of the present invention enables monitoring protein kinase activity in cerebrospinal fluid and detecting the effect of a pharmacologic compound on this activity. Furthermore, different neuronal disorders are reflected in the protein kinase activity.

Accordingly, within one embodiment of the present invention, a method is provided for analyzing CSF and determining the presence or development of a pathology, which can be neurological and/or psychiatric disorders, such as Alzheimer's disease, Huntington's disease, Parkinson's disease, Creutzfeldt-Jakob disease and other prion diseases, fronto temporal dementia, dystonia, ataxia's, schizophrenia, epilepsy, depression, brain tumors, brain irradiation, head trauma, multiple sclerosis, white matter disorders, metabolic disorders, acute and chronic encephalitic and vascular disease. The method comprises the steps of:

a) obtaining a sample of cerebrospinal fluid;

b) incubating said sample with ATP on an array of substrates; and,

c) obtaining a detectable phosphorylation profile, said profile resulting from the interaction of the cerebrospinal fluid sample with the array of substrates.

More preferably the substrates of the present invention are peptide substrates for protein kinases and the array of substrates is a flow-through array.

In another embodiment, the present invention relates to the use of a method according to the invention, for diagnosis of neurological and psychiatric disorders.

### DESCRIPTION OF THE FIGURES

FIG. 1 shows the results of an incubation of CSF samples on a PamChip®.

FIG. 2 shows analysis of the phosphorylation profiles differentiating between 3 classes of CSF samples having different pathologies

FIG. 3 shows the principal component analysis of the phosphorylation patterns obtained with CSF samples having different pathologies.

FIG. 4 provides, as depicted in the examples, a graphical representation where IL-1β induced IL-6 secretion by U373 astrocytoma cells and human primary astrocytes is reduced by IRAK1/4 inhibitor.

### DETAILED DESCRIPTION

Before the present method and devices used in the invention are described, it is to be understood that this invention is not limited to particular methods, components, or devices described, as such methods, components, and devices may, of course, vary. It is also to be understood that the terminology used herein is not intended to be limiting.

Unless defined otherwise, all technical and scientific terms used herein have the same meaning as commonly understood by one of ordinary skill in the art to which this invention belongs. Although any methods and materials similar or equivalent to those described herein may be used in the practice or testing of the present invention, the preferred methods and materials are now described.

In this specification and the appended claims, the singular forms “a”, “an”, and “the” include plural references unless the context clearly dictates otherwise.

The present application relates to the use of cerebrospinal fluid (CSF) for the classification, diagnosis, prognosis and prediction of treatment effects. More specifically the inventors have shown that, notwithstanding the low protein content in CSF, the method of the present invention enables monitoring protein kinase activity, and preferably endogenous protein kinase activity, in cerebrospinal fluid. The inventors surprisingly found that clinical and post mortem CSF both fresh and frozen contains active protein kinases. It was shown that the protein kinases in CSF are still able to phosphorylate other proteins or peptides. Furthermore, the inventors have surprisingly found that the profiles obtained with CSF from different sources are different. The profiles obtained for one specific disease are reproducible for a given disease state and specific profiles can be obtained for use in diagnosing patients whose particular pathology is unknown or otherwise unconfirmed. The inventors have therefore shown that neuronal disorders are reflected in a differential protein kinase activity which enables an early diagnosis of neurological and/or psychiatric disorders. The variable, disorder related, presence of protein kinases and their ability to phosphorylate specific peptides enables the analysis of CSF of a patient and identification of a certain pathology. More particularly, the present invention relates to a method for analyzing CSF and determining the presence or development of a pathology, which can be neurological diseases, psychiatric disorders, oncological diseases, metabolic diseases, immunological and auto immunological diseases, diseases of the nervous system and/or infectious diseases, preferably neurological and/or psychiatric disorders, such as Alzheimer's disease, Huntington's disease, Parkinson's disease, Creutzfeldt-Jakob disease and other prion diseases, fronto temporal dementia, dystonia, ataxia's, schizophrenia, epilepsy, depression, brain tumors, brain irradiation, head trauma, multiple sclerosis, white matter disorders, metabolic disorders, acute and chronic encephalitic and vascular disease.

By ‘enzymes’ we refer to proteins that are able to catalyze reactions wherein they convert substrates to products without themselves being part of the end products of the reaction. Monomers, oligomers or polymers composed of amino acids, nucleotides or sugars may be modified by enzymes. For protein kinases, the modified substrate might be either another enzyme or any other protein participating in the same signal transduction pathway. Enzymes that may be analyzed include, but are not limited to, oxidoreductases including dehydrogenases, reductases and oxidases; transferases including methyltransferases, carbamoyltransferases, transketolases, acetyltransferases, phosphorylases, phosphoribosyltransferases, sialyltransferase; phosphotransferases including kinases such as calcium/calmodulin dependent kinases, cyclin-dependent kinases, lipid signaling kinases, mitogen-activated protein kinases, PDK1-PKB/Akt, PKA, PKC, PKG, GSK-3beta, non-receptor protein tyrosine kinases, receptor protein tyrosine kinases, serine/threonine kinases, histidine kinases, hydrolases including lipases, esterases, hydrolases, protein phosphatases, phosphodiesterases, glucosidases, galactosidases, amidases, deaminases and pyrophosphatases; lyases including decarboxylases, aldolases, hydratases and ferrochelatases; isomerases including epimerases, isomerases, and mutases; ligases including GMP synthase, CTP synthase, NAD+ synthetase, and carboxylases. The methods according to the present invention are equally directed to enzymes without a known biologically active function.

Accordingly, in one embodiment of the present invention, methods are provided wherein the enzymatic activity is chosen from the group comprising kinase activity, phosphatase activity, protease activity, transferase activity, and proteinase activity. In a more preferred embodiment of the present invention, methods are provided wherein the enzymatic activity is kinase activity and more preferably protein kinase activity.

Kinases are a class of enzymes that transfer phosphate groups from high energy phosphate donors like ATP, GTP, CTP or UTP to a phosphate acceptor molecule. The phosphate acceptors may be small molecules like carbohydrates (e.g. glucose), nucleic acids (e.g. adenylate), lipids, or large molecules like proteins. Adenylate kinase (also known as ADK or myokinase) is an example of such a small molecule kinase. It is a phosphotransferase that catalyzes the interconversion of adenine nucleotides (2 ADP⇄ATP+AMP) and plays an important role in cellular energy homeostasis.

Protein kinases are a special class of kinases. Protein kinase activity is referred to as the activity of protein kinases. A protein kinase is a generic name for all enzymes that transfer a phosphate to a protein. About three to four percent of the human genome contains transcription information for the formation of protein kinases. Currently, there are about 518 known different protein kinases. However, because three to four percent of the human genome is a code for the formation of protein kinases, there may be many more separate kinases in the human body. A protein kinase is an enzyme that modifies proteins by covalently coupling phosphate groups to them. This process or activity is also referred to as phosphorylation. Phosphorylation can therefore be regarded as the process of the addition of a phosphate group to a substrate. Phosphorylation usually results in a functional change of the substrate by changing enzyme activity, cellular location, or association with other proteins. Up to 30% of all proteins may be modified by protein kinase activity, and kinases are known to regulate the majority of cellular pathways, especially those involved in signal transduction, the transmission of signals within the cell. The chemical activity of a protein kinase involves removing a phosphate group from ATP or GTP, or any other phosphate source, and covalently attaching it to amino acids such as serine, threonine, tyrosine, histidine, aspartic acid and/or glutamic acid that have a free hydroxyl group. Most known protein kinases act on both serine and threonine, others act on tyrosine, and a number acts on serine, threonine and tyrosine. The protein kinase activity monitored with the method of the present invention is preferably directed to protein kinases acting towards serine, threonine and/or tyrosine, preferably acting on both serine and threonine, on tyrosine or on serine, threonine and tyrosine and more preferably the method of the present invention if preferably directed to protein kinases acting towards serine and threonine.

Because protein kinases have profound effects on a cell, their activity is highly regulated. Kinases are turned on or off by for instance phosphorylation, by binding of activator proteins or inhibitor proteins, or small molecules, or by controlling their own location in the cell relative to their substrates. Deregulated protein kinase activity is a frequent cause of disease since protein kinases regulate many aspects that control for instance cell growth, movement and death.

Accordingly, within one embodiment of the present invention, a method is provided for analyzing CSF and determining the presence or development of a pathology, which can be neurological and/or psychiatric disorders, such as Alzheimer's disease, Huntington's disease, Parkinson's disease, Creutzfeldt-Jakob disease and other prion diseases, fronto temporal dementia, dystonia, ataxia's, schizophrenia, epilepsy, depression, brain tumors, brain irradiation, head trauma, multiple sclerosis, white matter disorders, metabolic disorders, acute and chronic encephalitic and vascular disease. The method comprises the steps of:

a) obtaining a sample of cerebrospinal fluid;

b) incubating said sample with ATP on an array of substrates; and,

c) obtaining a detectable phosphorylation profile, said profile resulting from the interaction of the cerebrospinal fluid sample with the array of substrates.

The method of the present invention enables the analysis of CSF and determining the activity of protein kinases is a highly sensitive and fast way. It should be noted that the method of the present invention measures the activity of protein kinases in CSF and therefore the method of the present invention measures the endogenous protein kinase activity.

The substrates as used herein, are meant to include proteins, hormone receptors, enzymes and peptides. In particular the substrates used are substrates for protein kinases, more in particular peptide substrates for protein kinases, even more particular the peptide substrates for protein kinases in Table 1, Table 2 and/or Table 3, most particularly using at least 2, 3, 4, 5, 9, 10, 12, 16, 20, 30, 40, 50, 60, 70, 80, 90, 100, 110, 120, 130 or 140 peptides of the peptide substrates for protein kinases in Table 1. In a preferred embodiment the array of substrates comprises at least two peptides selected from the group consisting of the peptides with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52. In a more preferred embodiment the array of substrates comprises or consists of the peptides with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52.

It should be noted that a person skilled in the art will appreciate that the kinase substrates used in the methods of the present invention and immobilized on the arrays of the invention may be the peptides as listed in Table 1, Table 2 and/or Table 3. These peptides can be used according to the methods or arrays of the present invention to measure the phosphorylation levels of phosphorylation sites of said peptides in the presence of protein kinase present in the samples. The phosphorylation levels of the individual phosphorylation sites present in said peptides may be measured and compared in different ways. Therefore the present invention is not limited to the use of peptides identical to any of the peptides as listed in Table 1, Table 2 and/or Table 3 as such. The skilled person may easily on the basis of the sequence of the peptides listed in Table 1, Table 2 and/or Table 3 design variants compared to the specific peptides in said tables and use such variants in a method for measuring phosphorylation levels of phosphorylation sites present in said peptides as listed in Table 1, Table 2 and/or Table 3. These variants may be peptides which have a one or more (2, 3, 4, 5, 6, 7, etc.) amino acids more or less than the given peptides and may also have amino acid substitutions (preferably conservative amino acid substitutions) as long as these variant peptides retain at least one or more of the phosphorylation sites of said original peptides as listed in said tables. Further the skilled person may also easily carry out the methods or construct arrays according to the present invention by using proteins (full length or N- or C-terminally truncated) comprising the amino acid regions of the peptides listed in Table 1, Table 2 and/or Table 3 as sources for studying the phosphorylation of sites present in the amino acid regions of the peptides listed in Table 1, Table 2 and/or Table 3. Also the skilled person may use peptide mimetics which mimick the peptides listed in Table 1, Table 2 and/or Table 3. The present invention also includes the use of analogs and combinations of these peptides for use in the method or arrays according to the present invention. The peptide analogs include peptides which show a sequence identity of more than 70%, preferably more than 80% and more preferably more than 90%.

As used herein “peptide” refers to a short truncated protein generally consisting of 2 to 100, preferably 2 to 30, more preferably 5 to 30 and even more preferably 13 to 18 naturally occurring or synthetic amino acids which can also be further modified including covalently linking the peptide bonds of the alpha carboxyl group of a first amino acid and the alpha amino group of a second amino acid by eliminating a molecule of water. The amino acids can be either those naturally occurring amino acids or chemically synthesized variants of such amino acids or modified forms of these amino acids which can be altered from their basic chemical structure by addition of other chemical groups which can be found to be covalently attached to them in naturally occurring compounds.

As used herein “protein” refers to a polypeptide made of amino acids arranged in a linear chain and joined together by peptide bonds between the carboxyl and amino groups of adjacent amino acid residues.

As used herein “peptide mimetics” refers to organic compounds which are structurally similar to peptides and similar to the peptide sequences list in Table 1, Table 2 and/or Table 3. The peptide mimetics are typically designed from existing peptides to alter the molecules characteristics. Improved characteristics can involve, for example improved stability such as resistance to enzymatic degradation, or enhanced biological activity, improved affinity by restricted preferred conformations and ease of synthesis. Structural modifications in the peptidomimetic in comparison to a peptide, can involve backbone modifications as well as side chain modification.

TABLE 1
list of 140 peptides used for
determining the kinase activity,
their sequence and Seq. Id. No.

| | Name | Sequence |
|---|---|---|
| 1 | ABL1_729_740_T729/S733/T735 | TEWRSVTLPRDL |
| 2 | ACM1_421_433_T428 | CNKAFRDTFRLLL |
| 3 | ACM1_444_456_T455/S451 | KIPKRPGSVHRTP |
| 4 | ACM4_456_468_T459/T463 | CNATFKKTFRHLL |
| 5 | ACM5_494_506_T501/T505/Y495 | CYALCNRTFRKTF |
| 6 | ACM5_498_510_T501/T505 | CNRTFRKTFKMLL |
| 7 | ADDB_696_708_S697/S699/S701/ | GSPSKSPSKKKKK |
| | S703 | |
| 8 | ADDB_706_718_T711/S713/S718 | KKKFRTPSFLKKS |
| 9 | ADRB2_338_350_S345/S346/Y350 | ELLCLRRSSLKAY |
| 10 | AKT1_301_313_T305/T308/T312 | KDGATMKTFCGTP |
| 11 | ANXA1_208_220_T215 | AGERRKGTDVNVF |
| 12 | ANXA2_16_28_T18/S17/S21/ | HSTPPSAYGSVKA |
| | S25/Y23 | |
| 13 | ATF2_47-59_T51/T53/T55 | VADQTPTPTRFLK |
| 14 | BCKD_45_57_T49/T51/S47/S52/ | ERSKTVTSFYNQS |
| | S57/Y54 | |
| 15 | CAC1C_1974_1986_S1975/S1981 | ASLGRRASFHLEC |
| 16 | CACD2_494_506_T501/T505 | LEDIKRLTPRFTL |
| 17 | CALD1_723_735_T724/S730 | KTPDGNKSPAPKP |
| 18 | CALD1_746_758_T751/T753 | INEWLTKTPDGNK |
| 19 | CBL_693_705_Y700 | EGEEDTEYMTPSS |
| 20 | CDC2_154_169_Y160/T161/T166/ | GIPIRVYTHEVVTLWY |
| | Y169 | |
| 21 | CDK7_163_175_T170/T175/S164/ | GSPNRAYTHQVVT |
| | Y169 | |
| 22 | CENPA_1_14_S7 | MGPRRRSRKPEAPR |
| 23 | CENP-C_725_737_T734/S732 | HHKLVLPSNTPNV |
| 24 | CFS1R_701_713_S713/Y708 | NIHLEKKYVRRDS |
| 25 | CFTR_730_742_S737/S742 | EPLERRLSLVPDS |
| 26 | CFTR_761_773_S768 | LQARRRQSVLNLM |
| 27 | CFTR_783_795_T787/T788/T791/ | IHRKTTASTRKVS |
| | S790/S795 | |
| 28 | CGHB_109_122_T117/T118/S116 | QCALCRRSTTDCG |
| 29 | CHK2_377_389_T378/T383/T387/ | ETSLMRTLCGTPT |
| | T389/S379 | |
| 30 | COF1_16_28_T24/S22/S23 | DMKVRKSSTPEEV |
| 31 | CREB1_126_138_S129/S133/Y134 | EILSRRPSYRKIL |
| 32 | CSK21_355_367_T360/S356/S357/ | ISSVPTPSPLGPL |
| | S362 | |
| 33 | DCX_49_61_T56/S57 | HFDERDKTSRNMR |
| 34 | ELK1_329_341_T336/S339/S341 | GGPGPERTPGSGS |
| 35 | ELK1_356_368_T359/T361/T363/ | LLPTHTLTPVLLT |
| | T368 | |
| 36 | ELK1_410_422_T417/S411/S416/ | ISVDGLSTPVVLS |
| | S422 | |
| 37 | EPB42_240_252_S247 | LLNKRRGSVPILR |
| 38 | ERBB2_679_691_T686/Y685 | QQKIRKYTMRRLL |
| 39 | ERF_519_531_T526/S531 | GEAGGPLTPRRVS |
| 40 | ESR1_160_172_T168/S167 | GGRERLASTNDKG |
| 41 | F263_454_466_T463/S461 | NPLMRRNSVTPLA |
| 42 | F264_436_448_S443/S444 | LNVAAVNTHRDRP |
| 43 | FIBA_569_581_S572/S576/S577/ | EFPSRGKSSSYSK |
| | S578/S580/Y579 | |
| 44 | FOXO3_25_37_T32/S26/S30 | QSRPRSCTWPLQR |
| 45 | GPR6_349_361_S350/S356/S358/ | QSKVPFRSRSPSE |
| | S360 | |
| 46 | GPSM2_394_406_S401 | PKLGRRHSMENME |
| 47 | GRB2_427_439_T439/S427/S434 | SRLRRRASQLKIT |
| 48 | GRIK1_718_730_T730/S725/S726 | EKMWAFMSSRQQT |
| 49 | GRIK2_708_720_S710/S711/ | FMSSRRQSVLVKS |
| | S715/S720 | |
| 50 | GSUB_61_73_T68 | KKPRRKDTPALHI |
| 51 | GYS2_1_14_T10/S6/S8/S11 | MLRGRSLSVTSLG |
| 52 | H2B1B_26_39_S32/S36/S38 | GKKRKRSRKESYSI |
| 53 | H2BR_26_38_S32/S36 | DGKKRKRSRKESY |
| 54 | H32_2_17_T3/T6/S10/T11 | RTKQTARKSTGGKAPR |
| 55 | HS90B_218_230_S225 | KEREKEISDDEAE |
| 56 | INSR_1368_1380_T1375/S1379 | KKNGRILTLPRSN |
| 57 | IPP1_28_40_T35/T38 | QIRRRRPTPATLV |
| 58 | K6PL_765_777_T769/T772/S774 | LEHVTRRTUSMDK |
| 59 | KAP2_91_103_T103/S91/S98 | SRFNRRVSVCAET |
| 60 | KAP3_106_118_T109/S113 | NRFTRRASVCAEA |
| 61 | KAPCG_191_205_T195/T197/ | VKGRTWTLCGTPEYL |
| | T201/Y204 | |
| 62 | KCC1A_170_182_T177/T181/ | DPGSVLSTACGTP |
| | S173/S176 | |
| 63 | KCC2G_278_289_S280/T287 | VASMMHRQETVE |
| 64 | KCNA1_438_450_T448/S439/ | DSDLSRRSSSTMS |
| | S442/S445/S446/S447/S450 | |
| 65 | KCNA2_442_454_T452/S447/ | PDLKKSRSASTIS |
| | S449/S451/S454 | |
| 66 | KCNA3_461_473_T471/S468/ | EELRKARSNSTLS |
| | S470/S473 | |
| 67 | KCNA6_504_516_T515/S511/Y512 | ANRERRPSYLPTP |
| 68 | KCNB1_489_501_T491/T494/ | KWTKRTLSETSSS |
| | T498/S496/S499/S500/S501 | |
| 69 | KIF11_920_932_T924/T926/ | LDIPTGTTPQRKS |
| | T927/S932 | |
| 70 | KPB1_1011_1024_S1018/S1020/ | QVEFRRLSISAES |
| | S1023 | |
| 71 | KPCB_18_30_S24 A24S | RFARKGSLRQKNV |
| 72 | KPCB_625_638_T633 | AENFDRFFTRHPPV |
| 73 | LA_359_371_T362/S366 | GKKTKFASDDEHD |
| 74 | LAM1_15_27_T18/T19/T24/S22/ | GGPTTPLSPTRLS |
| | S27 | |
| 75 | LMNA_192_204_T199 | DAENRLQTMKEEL |
| 76 | MARCS_151_163_S158/S162 | KKKKKRFSFKKSF |
| 77 | MARCS_159_171_S162/S166/S169 | FKKSFKLSGFSFK |
| 78 | MBP_222_234_T229/T232 | HFFKNPVTPRTPP |
| 79 | MBP_225_238_T229/T232/S236 | KNIVTPRTPPPSQ |
| 80 | MK10_216_228_T218/T223/T228/ | AGTSFMMTPYVVT |
| | S219/Y225 | |
| 81 | MP2K1_280_292_T285/T291 | GDAAETPPRPRTP |
| 82 | MP2K1_286_298_T291/S297/S298 | PPRPRTPGRPLSS |
| 83 | MPH6_140_152_T147 | EDENGDITPIKAK |
| 84 | MPIP3_208_220_S209/Y212/ | RSGLYRSPSMPEN |
| | S214/S216 | |
| 85 | MYBB_513_525_T515/T518/T520 | DNTPHTPTPFKNA |
| 86 | MYC_51_63_T58/S62 | KKFELLPTPPLSP |
| 87 | MYPC3_268_280_T274/S269/S275 | LSAFRRTSLAGGG |
| 88 | NCF1_296_308_S303/S304 | RGAPPRRSSIRNA |
| 89 | NCF1_321_333_S328/Y324 | QDAYRRNSVRFLQ |
| 90 | NCF1_372_384_T382/S379/S381 | DLILNRCSESTKR |
| 91 | NEK2_171_184_T174/T178/S183/ | FAKTFVGTPYMS |
| | Y180/Y181 | |
| 92 | NEK3_158_170_T161/T165/Y162/ | FACTYVGTPYYVP |
| | Y167/Y168 | |
| 93 | NFKB1_330_342_T341/S337/S342 | FVQLRRKSDLETS |
| 94 | NMDZ1_890_902_S890/S896/ | SFKRRRSSKDTST |
| | S897/T900/S901/T902 | |
| 95 | NR4A1_344_356_S351 | GRRGRLPSKPKQP |
| 96 | NTRK3_824_836_T831/Y834 | LHALGKATPIYLD |
| 97 | P2AB_297_309_T304/Y307 | EPHVTRRTPDYFL |
| 98 | P53_308_323_T312/S313/S314/ | LPNNTSSSPQPKKKPL |
| | S315 | |
| 99 | PDE5A_95_107_T96/T98/S102/ | GTPTRKISASEFD |
| | S104 | |
| 100 | PHS1_7_19_S14 | QEKRRQISIRGIV |
| 101 | PLEC1_4635_4647_T4646/S4636/ | RSGSRRGSFDATG |
| | S4638/S4642 | |
| 102 | PLEK_106_118_T114/S113/S117 | GQKFARKSTRRSI |
| 103 | PLM_76_88_T79/S82/S83/S88 | EEGTFRSSIRRLS |
| 104 | PPLA_9_21_T17/S10/S16 | RSAIRRASTIEMP |
| 105 | PRGR_786_798_S793 | EQRMKESSFYSLC |
| 106 | PTK6_436_448_T445/S442/S443/ | ALRERLSSFTSYE |
| | S446/Y447 | |
| 107 | PTN12_32_44_T40/T44/S39/Y42 | FMRLRRLSTKYRT |
| 108 | Q5HY18_106_111_S110 | GLRRWSLGGLRRWSL |
| 109 | Q6ICU1_105_118_S106G_S110 | EGLRSRSTRMSTVS |
| 110 | RAB1A_186_198_T194/S187/S193 | KSNVKIQSTPVKQ |
| 111 | RADI_559_569_Y562/T564 | RDKYKTLRQIR |
| 112 | RAF1_252_264_T258/T260/S252/ | SQRQRSTSTPNVH |
| | S257/S259 | |
| 113 | RAP1B_172_184_S179/S180 | PGKARKKSSCQLL |
| 114 | RB_242_254_T252/S249 | AVIPINGSPRTPR |
| 115 | RB_804_816_S807/S811 | IYISPLKSPYKIS |
| 116 | RBL2_410_422_T417/T421/S413/ | KENSPCVTPVSTA |
| | S420 | |
| 117 | RBL2_632_644_T642/S639 | DEICIAGSPLTPR |
| 118 | RBL2_635_637_T642/T647/S639 | CIAGSPLTPRRVT |
| 119 | RBL2_655_667_S662 | GLGRSITSPTTLY |
| 120 | RBL2_687_699_T694/S688/S690 | DSPSDGGTPGRMP |
| 121 | RBL2_955_967_T961/S962/S965/ | ELNKDRTSRDSSP |
| | S966 | |
| 122 | RBL2_959_971_T961/S962/S965/ | DRTSRDSSPVMRS |
| | S966/S971 | |
| 123 | REL_260_272_S267/S272 | KMQLRRPSDQEVS |
| 124 | RS6_228_240_S235/S236/S240 | IAKRRRLSSLRAS |
| 125 | RYR1_4317_4329_T4324 | VRRLRRLTAREAA |
| 126 | SCN7A_898_910_S905/S906 | KNGCRRGSSLGQI |
| 127 | SRC_412_424_T419/Y418 | LIEDNEYTARQGA |
| 128 | SRC8_CHICK_423_435_Y430 | KTPSSPVYQDAVS |
| 129 | STK6_283_295_S283/S284/T287/ | SSRRTTLCGTLDY |
| | T288/T292/Y295 | |
| 130 | STMN2_90_102_S97 | AAGERRKSQEAQV |
| 131 | TAU_523_535_T528/T533/S524/ | GSRSRTPSLPTPP |
| | S526/S530 | |
| 132 | TLE_242_254_T248/T249/S245 | EPPSPATTPCGKV |
| 133 | TNR7_212_224_S219/S224/Y217 | HQRRKYRSNKGES |
| 134 | TY3H_63_77_S70 | RFIGRRQSLIEDARK |
| 135 | VASP_149_161_S156 | EHIERRVSNAGGP |
| 136 | VASP_231_243_S238 | GAKLRKVSKQEEA |
| 137 | VASP_270_282_T277 | LARRRKATQVGEK |
| 138 | VIGLN_287_299_T293/T294/T295 | EEKKKKTTTIAVE |
| 139 | VTNC_390_402_T400/S393/S397 | NQNSRRPSRATWL |
| 140 | ZAP70_486_498_T493/S490/ | LGADDSYYTARSA |
| | S496/Y491/Y492 | |

The term ‘cerebrospinal fluid’ or ‘CSF’ as used herein, refers to the fluid that surrounds the bulk of the central nervous system, as described in Physiological Basis of Medical Practice (J. B. West, ed., Williams and Wilkins, Baltimore, Md. 1985). CSF includes ventricular CSF and spinal cord CSF.

The term ‘phosphorylation profile’ or ‘kinase activity profile’ as used herein, refers to the response of the substrates, preferably kinase substrates generated during the incubation of at least two such substrates with a CSF sample.

The inventors have found that a particular enzymatic activity such as for instance a kinase activity can be monitored in samples of CSF. This is due to the protein kinases present in CSF. Therefore, contacting the CSF samples with an array of two or more substrates and preferably kinase substrates, and more in particular peptide substrates for protein kinases, in the presence of ATP will lead to a phosphorylation of the kinase substrates.

Alternatively, the phosphorylation of the substrates and/or peptide substrates for protein kinases can be performed in the absence of exogenous ATP. When no ATP is added during the incubation of CSF on the array of substrates, the endogenous ATP, the ATP naturally present in the CSF, will act as the prime source of ATP.

This response of the kinase substrates, also referred to as the phosphorylation profile or kinase activity profile of the sample, can be determined using a detectable signal. The signal is the result from the interaction of the sample with the array of substrates more specifically with the peptide substrates on this array that have been modified by the incubation with the sample. The response of the array of substrates can be monitored using any method known in the art. The response of the array of substrates is determined using a detectable signal, said signal resulting from the interaction of the sample with the array of substrates. As mentioned hereinbefore, in determining the interaction of the sample with the array of substrates the signal is either the result of a change in a physical or chemical property of the detectably labeled substrates, or indirectly the result of the interaction of the substrates with a detectably labeled molecule capable of binding to the substrates or the result of a chemical reaction of a detectable compound with the modified substrate (e.g. Pro-Q Diamond phosphoprotein stain). For the latter, the molecule that specifically binds to the modified peptide substrates of interest (e.g., antibody or polynucleotide probe) can be detectably labeled by virtue of containing an atom (e.g., radionuclide), molecule (e.g. fluorescein), or complex that, due to a physical or chemical property, indicates the presence of the molecule. A molecule may also be detectably labeled when it is covalently bound to or otherwise associated with a “reporter” molecule (e.g., a biomolecule such as an enzyme) that acts on a substrate to produce a detectable atom, molecule or other complex.

Detectable labels suitable for use in the present invention include any composition detectable by spectroscopic, photochemical, biochemical, immunochemical, electrical, optical or chemical means. Labels useful in the present invention include biotin for staining with labeled avidin or streptavidin conjugate, magnetic beads (e.g., Dynabeads'), fluorescent dyes (e.g., fluorescein, fluorescein-isothiocyanate (FITC), Texas red, rhodamine, green fluorescent protein and all variants known in the art, enhanced green fluorescent protein, lissamine, phycoerythrin, Cy2, Cy3, Cy3.5, Cy5, Cy5.5, Cy7, FluorX [Amersham], SYBR Green I & II [Molecular Probes], Alexa dyes and the like), radiolabels, enzymes (e.g., hydrolases, particularly phosphatases such as alkaline phosphatase, esterases and glycosidases, or oxidoreductases, particularly peroxidases such as horse radish peroxidase, and the like), substrates, cofactors, inhibitors, chemilluminescent groups, chromogenic agents, and colorimetric labels such as colloidal gold or colored glass or plastic (e. g., polystyrene, polypropylene, latex, etc.) beads.

Means of detecting such labels are well known to those of skill in the art. Thus, for example, chemiluminescent and radioactive labels may be detected using photographic film or scintillation counters, and fluorescent markers may be detected using a photodetector to detect emitted light (e.g., a CCD camera, or a method as in fluorescence-activated cell sorting). Enzymatic labels are typically detected by providing the enzyme with a substrate and detecting a colored reaction product produced by the action of the enzyme on the substrate. Preferentially a compound that precipitates upon conversion is used. Colorimetric labels are detected by simply visualizing the colored label. Thus, for example, where the label is a radioactive label, means for detection include a scintillation counter, photographic film as in autoradiography, or storage phosphor imaging. Where the label is a fluorescent label, it may be detected by exciting the fluorochrome with the appropriate wavelength of light and detecting the resulting fluorescence. The fluorescence may be detected visually, by means of photographic film, by the use of electronic detectors such as charge coupled devices (CCDs) or photomultipliers and the like. Similarly, enzymatic labels may be detected by providing the appropriate substrates for the enzyme and detecting the resulting reaction product. Also, simple colorimetric labels may be detected by observing the color associated with the label. Fluorescence resonance energy transfer has been adapted to detect binding of unlabeled ligands, which may be useful on arrays.

In a particular embodiment of the present invention the response of the array of substrates to the sample is determined using detectably labeled antibodies; more in particular antibodies directly or indirectly labeled with a fluorescent label. In those embodiments of the invention where the substrates consist of kinase substrates, the response of the protein kinase substrates is determined using fluorescently labelled anti-phosphotyrosine antibodies, fluorescently labelled anti-phosphoserine or fluorescently labelled anti-phosphothreonine antibodies. The use of fluorescently labelled anti-phosphotyrosine antibodies or fluorescently labelled anti-phosphoserine or fluorescently labelled anti-phosphothreonine antibodies in the method of the present invention, allows real-time or semi real-time determination of the protein kinase activity and accordingly provides the possibility to express the protein kinase activity as the initial velocity of protein kinase derived from the activity over a certain period of incubation of the sample on the protein kinase substrates.

Accordingly, the present invention provides a phosphorylation profile obtained using detectably labelled antibodies.

The array of substrates is preferably a microarray of substrates wherein the substrates are immobilized onto a solid support or another carrier. The immobilization can be either the attachment or adherence of two or more substrate molecules to the surface of the carrier including attachment or adherence to the inner surface of said carrier in the case of e.g. a porous or flow-through solid support.

In a preferred embodiment of the present invention, the substrates are substrates for protein kinases.

More preferably the substrates of the present invention are peptide substrates for protein kinases.

In a preferred embodiment of the present invention, the substrates are at least two substrates for protein kinases selected from the group consisting of the substrates for protein kinases with any of Seq. Id. No. 1 to 140, most particularly using at least two peptides selected from the group consisting of the peptides with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52. In a more preferred embodiment the substrates are the peptides with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52.

In a preferred embodiment of the present invention, the array of substrates is a flow-through array. The flow-through array as used herein could be made of any carrier material having oriented through-going channels as are generally known in the art, such as for example described in PCT patent publication WO 01/19517. Typically the carrier is made from a metal oxide, glass, silicon oxide or cellulose. In a particular embodiment the carrier material is made of a metal oxide selected from the group consisting of zinc oxide, zirconium oxide, tin oxide, aluminum oxide, titanium oxide and thallium; in a more particular embodiment the metal oxide consists of aluminum oxide.

In an alternative embodiment, the kinase activity in CSF can be determined in a monoplex and/or multiplex setup. This type of setup for measuring the kinase activity in

CSF can for instance be based on the use of bead assays, or a multitude of single kinase assays or other methods known to those skilled in the art.

Alternatively, the method of the present invention can comprise steps where the kinase activity in CSF is measured by adding ATP and analyze the composition of the proteins by using methods known in the art such as, but not limited to 2D gel electrophoresis.

In a preferred embodiment of the present invention the phosphorylation profile is compared to a set of sample profiles of known neurological and psychiatric pathologies. These kinase activity profiles of known neurological and psychiatric pathologies can be present in the form of a database and the profiles can for instance be obtained from earlier conducted tests. The comparison can be used to ascertain the particular pathology of the cerebrospinal fluid being analysed. By comparing the activity profile with a large set of activity profiles from a database, this will render the method of the present invention more specific and precise.

Accordingly, within one embodiment of the present invention, a method is provided for analyzing CSF and determining the presence or development of a pathology, which can be neurological and/or psychiatric disorders, such as Alzheimer's disease, Huntington's disease, Parkinson's disease, Creutzfeldt-Jakob disease and other prion diseases, fronto temporal dementia, dystonia, ataxia's, schizophrenia, epilepsy, depression, brain tumors, brain irradiation, head trauma, multiple sclerosis, white matter disorders, metabolic disorders, acute and chronic encephalitic and vascular disease. The method comprises the steps of:

a) obtaining a sample of cerebrospinal fluid;

b) incubating said sample with ATP on an array of substrates;

c) obtaining a detectable phosphorylation profile, said profile resulting from the interaction of the cerebrospinal fluid sample with the array of substrates; and,

d) comparing the phosphorylation profile obtained in step (c) to a set of sample profiles of known neurological and psychiatric pathologies to ascertain the particular pathology of the cerebrospinal fluid being analysed.

In a preferred embodiment of the present invention, the pathology is preferably a neurological or a psychiatric disorder, preferably chosen from the group comprising neurological and/or psychiatric disorders, such as Alzheimer's disease, Huntington's disease, Parkinson's disease, Creutzfeldt-Jakob disease and other prion diseases, fronto temporal dementia, dystonia, ataxia's, schizophrenia, epilepsy, depression, brain tumors, brain irradiation, head trauma, multiple sclerosis, white matter disorders, metabolic disorders, acute and chronic encephalitic and vascular disease.

In an alternative embodiment of the present invention the method further comprises the presence of one or more protein kinase inhibitors in step b). In another embodiment the method further comprises the presence of one or more protein phosphatases in step b).

By providing a protein kinase inhibitor in the step where the kinase activity of the CSF sample is determined, it was surprisingly shown that the presence of the protein kinase inhibitor resulted in a more straightforward, less complicated and more discriminative activity profile. This surprising effect is due to the promiscuous characteristics of protein kinases. This results in a more efficient and less complicated analysis of the kinase activity profiles.

In another embodiment, the present invention relates to a method according to the present invention, an array according to the present invention, the use of a method according to the invention and/or a phosphorylation profile obtained by the method of the present invention, for the classification, diagnosis, prognosis and/or monitoring of neurological and psychiatric disorders. For example the method of the present invention can be used to diagnose neurological and/or psychiatric disorders, such as Alzheimer's disease, Huntington's disease, Parkinson's disease, Creutzfeldt-Jakob disease and other prion diseases, fronto temporal dementia, dystonia, ataxia's, schizophrenia, epilepsy, depression, brain tumors, brain irradiation, head trauma, multiple sclerosis, white matter disorders, metabolic disorders, acute and chronic encephalitic and vascular disease. The present invention also relates to the prediction and monitoring of treatment effects of said neurological and psychiatric disorders.

The present invention further relates to a method according to the present invention, an array according to the present invention and/or the use of a method according to the invention, for diagnostical, prognostical, and/or treatment predictive purposes. The kinase activity profiles obtained through the method of the present invention can for instance be used to assess the likelihood of a particular favourable or unfavourable outcome, susceptibility (or lack thereof) to a particular therapeutic regimen, etc. Therefore the method of the present invention also relates to the use of the method of the present invention to assess the susceptibility of a biological species having a specific disease state or cellular condition to a drug.

Therefore, the method of the present invention also relates to a method where CSF is used for drug discovery and/or drug screening comprising the steps of:

a) obtaining a sample of cerebrospinal fluid;

b) determining kinase activity of said sample by incubating said sample with ATP on an array of two or more substrates, preferably peptide substrates for protein kinases , thereby generating a kinase activity profile;

c) determining kinase activity of said sample by incubating said sample with ATP in the presence of a pharmacological compound and/or drug on an array of two or more substrates, preferably peptide substrates for protein kinases , thereby generating a kinase activity profile; and,

d) inferring the influence of said pharmacological compound and/or drug on the kinase activity profile, whereby an inhibition profile is generated by comparing the kinase activity profiles obtained in steps b) and c).

The present invention also relates to a method according to the present invention, an array according to the present invention, the use of the method of the present invention and/or a phosphorylation profile obtained by the method of the present invention for drug discovery and/or screening. By providing a method comprising the steps of:

a) obtaining a sample of cerebrospinal fluid;

b) determining kinase activity of said sample by incubating said sample with ATP on an array of two or more substrates, preferably peptide substrates for protein kinases , thereby generating a kinase activity profile;

c) determining kinase activity of said sample by incubating said sample with ATP in the presence of a pharmacological compound and/or drug on an array of two or more substrates, preferably peptide substrates for protein kinases, thereby generating a kinase activity profile;

d) inferring the influence of said pharmacological compound and/or drug on the kinase activity profile, whereby an inhibition profile is generated by comparing the kinase activity profiles obtained in step b) and c).

The pharmacological compound or drug as used in the present application can be any type of pharmacological active compound and/or drug and preferably a pharmacological compound and/or drug effecting kinase activity. The pharmacological compound and/or drug is preferably a kinase inhibitor, a kinase activator, a phosphatase inhibitor and/or a protease inhibitor.

This method enables the assessment of the pharmaceutical value and/or the clinical value of said pharmacological compound and/or drug and enables the assessment of the susceptibility to said pharmacological compound and/or drug of a biological species having a specific disease state or cellular condition. This method enables the prediction of the response of cells, tissues, organs and/or warm-blooded animals to said pharmacological compound and/or drug and determine the clinical outcome of a therapy with said pharmacological compound and/or drug. This method was found particular useful in the prediction of response to said pharmacological compound and/or drug, i.e. to enable the distinction between responders and non-responders in the treatment of cells, tissues, organs or warm-blooded animals with the pharmacological compound and/or drug to be tested, and in compound differentiation.

The pharmacological compound as used herein can be any kind of chemical substance for instance used in the treatment, cure, prevention, or diagnosis of disease or used to otherwise enhance physical or mental well-being. Preferably this drug is a kinase inhibitor.

The method of the present invention therefore relates to the use of the method of the present invention, wherein the inhibition profile is generated using an array of substrates comprising at least two peptides selected from the peptide substrates for protein kinases with sequence numbers 1 to 140.

The present invention relates in another embodiment to an array of substrates comprising at least two substrates for protein kinases selected from the group consisting of the substrates for protein kinases with any of Seq. Id. No. 1 to 140, most particularly using at least two peptides selected from the group consisting of the peptides with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52. In a more preferred embodiment the substrates are the peptides with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52.

In another embodiment of the present invention, a diagnostic kit, that enables performing the method of the present invention, is provided. Such a diagnostic kit would comprise at least one array containing at least two substrates for protein kinases selected from the group consisting of the substrates for protein kinases with any of Seq. Id. No. 1 to 140, most particularly using at least two peptides selected from the group consisting of the peptides with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52, and more preferably array contains substrates with any of Seq. Id. No. 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52. Said diagnostic kit would furthermore comprise ATP, BSA, buffer solutions and ingredients for detection of generated phosphorylation profiles.

The present invention also relates to a method for performing diagnosis on CSF samples, the method comprising: providing a computer platform comprising reference kinase activity profiles from CSF samples associated with neurological and/or psychiatric disorders and comparing the kinase activity profile of the CSF samples analysed using the method of the present invention with said reference profiles. The computer program can be provided on a data carrier comprising reference kinase activity profiles. Said computer program would enable performing diagnosis on the CSF samples. Furthermore, said computer program can be used for diagnostical purposes, prognostical purposes, for the prediction of the clinical outcome of a therapy and for treatment predictive purposes.

Furthermore, the present invention relates to a phosphorylation profile obtained by the method of the present invention, wherein said phosphorylation profile is specific for a certain neurological and/or psychiatric pathology. Furthermore, said phosphorylation profile can be used for diagnostical and/or prognostical purposes, the classification, and/or monitoring of disease progression of neurological and psychiatric disorders as well as the prediction and monitoring of treatment effects of said neurological and psychiatric disorders and/or for the prediction of the clinical outcome of a therapy.

### EXAMPLES

### Example 1

The method of the present invention has been optimized to allow the measurement of the kinase activity in cerebrospinal fluid. CSF was obtained through a lumbar punction from patients suffering from Alzheimer's disease and control patients. A 10 μl aliquot of cerebrospinal fluid was added to a kinase incubation mixture containing ATP, and placed on a PamChip® STK array that was blocked with 2% BSA. After loading of the reaction mixtures onto Pamchip arrays comprising 140 substrates for protein kinases, incubation was commenced thereby measuring the kinase activity of the sample. As controls, arrays were incubated without ATP or without CSF. After 60 cycles of pumping the incubation mixture through the array, the mixture was removed and the array washed three times with PBS. Detection antibodies were added after removal of the wash buffer from the array. Images of the array were taken during the incubation of the array with the detection antibodies and after 30 cycles of incubation After 30 cycles of incubation and imaging, the antibody mixture was removed and the array was washed with PBS. Images were collected at different exposure times. Signals for each spot on the image were quantified. The signals intensities are used for further analysis.

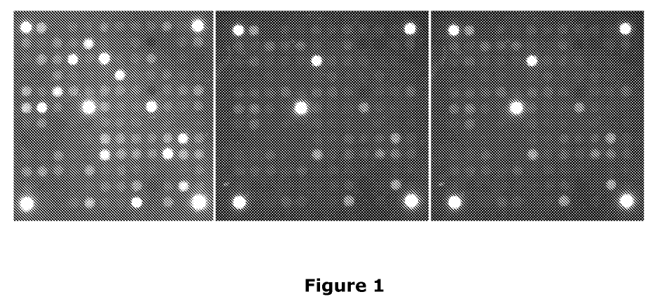

FIG. 1 shows the results of the incubation of the samples on a PamChip®. Whereas the samples containing no ATP (FIG. 1b) and no CSF (FIG. 1c) show identical patterns, the incubation with the sample containing CSF and ATP shows a unique phosphorylation profile. The corner spots are phosphorylated peptides, used as positive controls.

### Example 2

CSF samples obtained from 3 classes of patients: control (2 samples), non-demented patients (7 samples) and demented patients (7 samples) were incubated as described in example 1 on PamChip® STK arrays. The fluorescence from the spots in the images was quantified for quantitative analysis.

For each peptide a one way ANOVA was performed to identify peptides with a significant difference between any of the 3 patient classes. Table 2 lists 44 out of the 140 peptides that have a probability p for equal means over the 3 patient classes of p<0.01.

TABLE 2
Peptides with p < 0.01 from the ANOVA analysis.

| Seq. Id. No | Peptide |
|---|---|
| 80 | ‘MK10_216_228_T218/T223/T228/S219/Y225’ |
| 29 | ‘CHK2_377_389_T378/T383/T387/T389/S379’ |
| 9 | ‘ADRB2_338_350_S345/S346/Y350’ |
| 107 | ‘PTN12_32_44_T40/T44/S39/Y42’ |
| 108 | ‘Q5HY18_106_111_S110’ |
| 79 | ‘MBP_225_238_T229/T232/S236’ |
| 55 | ‘HS90B_218_230_S225’ |
| 24 | ‘CFS1R_701_713_S713/Y708’ |
| 19 | ‘CBL_693_705_Y700’ |
| 31 | ‘CREB1_126_138_S129/S133/Y134’ |
| 120 | ‘RBL2_687_699_T694/S688/S690’ |
| 36 | ‘ELK1_410_422_T417/S411/S416/S422’ |
| 6 | ‘ACM5_498_510_T501/T505’ |
| 57 | ‘IPP1_28_40_T35/T38’ |
| 95 | ‘NR4A1_344_356_S351’ |
| 99 | ‘PDE5A_95_107_T96/T98/S102/S104’ |
| 116 | ‘RBL2_410_422_T417/T421/S413/S420’ |
| 34 | ‘ELK1_329_341_T336/S339/S341’ |
| 12 | ‘ANXA2_16_28_T18/S17/S21/S25/Y23’ |
| 22 | ‘CENPA_1_14_S7’ |
| 129 | ‘STK6_283_295_S283/S284/T287/T288/T292/Y295’ |
| 32 | ‘CSK21_355_367_T360/S356/S357/S362’ |
| 18 | ‘CALD1_746_758_T751/T753’ |
| 106 | ‘PTK6_436_448_T445/S442/S443/S446/Y447’ |
| 47 | ‘GRB2_427_439_T439/S427/S434’ |
| 132 | ‘TLE_242_254_T248/T249/S245’ |
| 71 | ‘KPCB_18_30_S24_A24S’ |
| 38 | ‘ERBB2_679_691_T686/Y685’ |
| 125 | ‘RYR1_4317_4329_T4324’ |
| 127 | ‘SRC_412_424_T419/Y418’ |
| 117 | ‘RBL2_632_644_T642/S639’ |
| 62 | ‘KCC1A_170_182_T177/T181/S173/S176’ |
| 15 | ‘CAC1C_1974_1986_S1975/S1981’ |
| 51 | ‘GYS2_1_14_T10/S6/S8/S11’ |
| 128 | ‘SRC8_CHICK_423_435_Y430’ |
| 103 | ‘PLM_76_88_T79/S82/S83/S88’ |
| 8 | ‘ADDB_706_718_T711/S713/S718’ |
| 139 | ‘VTNC_390_402_T400/S393/S397’ |
| 83 | ‘MPH6_140_152_T147’ |
| 5 | ‘ACM5_494_506_T501/T505/Y495’ |
| 94 | ‘NMDZ1_890_902_S890/S896/S897/T900/S901/T902’ |
| 45 | ‘GPR6_349_361_S350/S356/S358/S360’ |
| 87 | ‘MYPC3_268_280_T274/S269/S275’ |
| 52 | ‘H2B1B_ 26_39_S32/S36/S38’ |

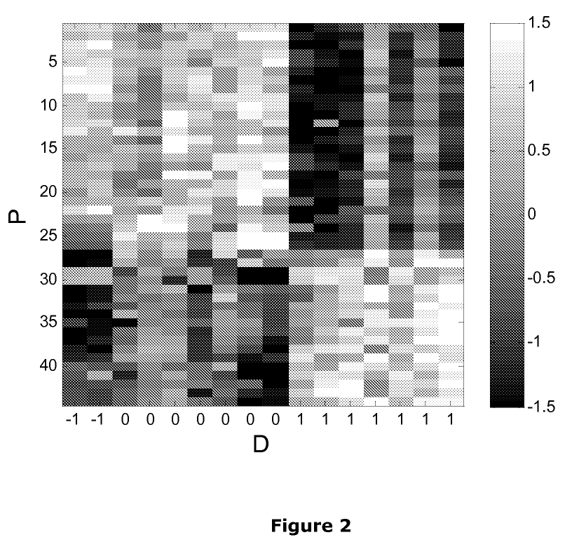

FIG. 2 is a map representing the phosphorylation patterns obtained with the CSF samples. The data only show the peptides selected by the One Way ANOVA analysis (table 2). The data was normalized per peptide by taking z-scores. On the horizontal axis (marked D) the 3 patient classes are indicated by −1 (control patients), 0 (non-demented patients) and 1 (demented patients). Along the vertical axis (marked P) the included peptides are sorted according to their z-score in the demented patient class. The results in Table 2 and FIG. 2 show that a clear differentiation can be made between the CSF samples from the different patient classes.

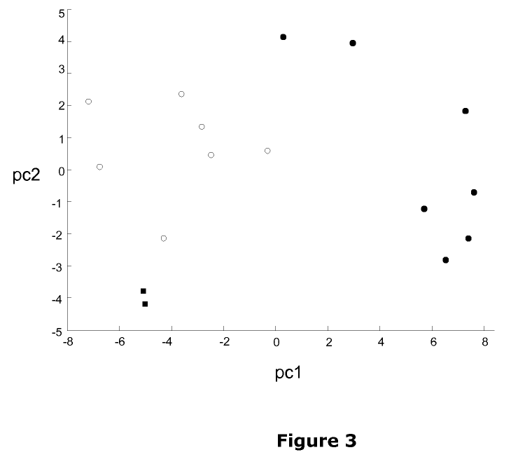

FIG. 3 shows the principal component analysis of the phosphorylation profiles in FIG. 2. In FIG. 3 the scores of each sample on the first two principal components is shown. The horizontal axis (marked pc1) represents the first principal component, the vertical axis (marked pc2) represents the second principal component. CSF samples obtained from control, non-demented and demented patients are represented by black squares, open circles, and black circles, respectively.

### Example 3

The present example shows how the method of the present invention can be used for the identification of protein kinases involved in Alzheimer's disease.

A 10 μl aliquot of freshly frozen post mortem cerebrospinal fluid was added to a kinase incubation mixture containing ATP and detection antibodies and placed on a PamChip®

STK array that was blocked with 2% BSA. After loading of the reaction mixtures onto Pamchip arrays comprising 140 substrates for protein kinases, incubation was commenced thereby measuring the kinase activity of the sample. As controls, arrays were incubated without ATP or without CSF. After 60 cycles of pumping the incubation mixture through the array, the mixture was removed and the array washed three times with PBS. A mixture of detection antibodies was added to the array and pumped up and down. Images were made at intervals of ten cycles of pumping. After 60 cycles of incubation and imaging, the detection mixture was removed and the array was washed with PBS. Images were collected at different exposure times. Signals for each spot on the image were quantified. The signals intensities were used for further analysis. The signals obtained in the incubations without ATP were subtracted from the signals obtained in the presence of ATP. Table 2 illustrates the differences in phosphorylation of peptide markers with Seq. Id. Nos. 4, 5, 6, 43, 63, 77, 97 and 111 in samples from non-demented (CSF 1-3) and demented patients (CSF 4-6).

TABLE 3

| | CSF1 | CSF2 | CSF3 | CSF4 | CSF5 | CSF6 |
|---|---|---|---|---|---|---|
| | Non-demented control, | | | Alzheimer's disease, | | |
| | br 0, O | | | br. 6, C | | |
| Seq. Id. No. 4 | −134 | −77 | 62 | 663 | 366 | 548 |
| Seq. Id. No. 5 | −123 | 457 | 546 | 1415 | 1293 | 1361 |
| Seq. Id. No. 6 | 56 | 228 | 85 | 1291 | 920 | 664 |
| Seq. Id. No. 43 | 19 | 9 | 7 | 552 | 533 | 503 |
| Seq. Id. No. 63 | −882 | −124 | −398 | 466 | 327 | 898 |
| Seq. Id. No. 77 | −220 | −67 | 78 | 661 | 580 | 404 |
| Seq. Id. No. 97 | 116 | 222 | 134 | 268 | 417 | 515 |
| Seq. Id. No. 111 | 882 | 2856 | 633 | 4771 | 4429 | 3756 |

The measurements of the kinase activity of post mortem CSF samples obtained from Alzheimer patients and non-demented cases indicated that the phosphorylation profiles on a PamChip STK array were clearly different. More specifically, the difference in kinase activity was found to be associated with protein kinases of the IRAK family. This conclusion was confirmed by comparing the phosphorylation profiles of these samples and with phosphorylation profiles generated by recombinant IRAK-4 kinase. The presence of IRAK-4 in post mortem brain tissue has further been confirmed by Western blot analyses using commercially available antibodies.

The involvement of protein kinases of the IRAK family in Alzheimer's disease was further confirmed by determining the IRAK-4 expression by immunohistochemistry using post mortem brain tissue derived from 22 different cases, 11 cases of Alzheimer's disease and 11 non-demented control cases. Immunohistochemical staining shows localization of IRAK-4 in astrocytes and microglia. These results were obtained using different commercially available antibodies.

The IRAK-4 expression in astrocytes was further validated in vitro. Western blot analysis and immunocytochemistry shows presence of IRAK-4 in U373 cells (astrocytoma cell line) and primary human adult astrocytes obtained after surgery or isolated from post mortem derived brain tissue. Staining for the presence of IRAK-4 on Western blot and immunocytochemistry was performed using commercially available antibodies.

### Example 4

The present example shows how the protein kinases involved in Alzheimer's disease identified in Example 3 provide targets for the treatment of Alzheimer's Disease.

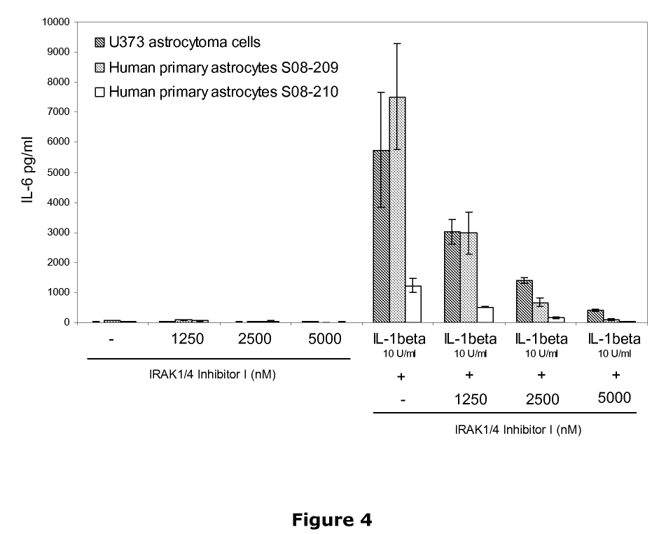

IL-1β has been implicated in both the initiation and propagation of neuroinflammatory changes seen in Alzheimer's disease patients. One of the main mechanisms of IL-1β is the induction of interleukin 6 (IL-6) secretion, which propagates the neuroinflammatory response in Alzheimer's disease patients. Using primary human adult astrocytes this inflammatory response as well as modulators (i.e. potential drugs for therapy) can be studied in vitro. FIG. 4 shows the secretion of IL-6 by U373 astrocytoma cells and human primary astrocytes after 6 hours in culture. In the presence of IL-1β (10 U/ml) these cells secrete IL-6 in the culture supernatant, which can be measured by ELISA. The presence of IRAK1/4 inhibitor I dose-dependently inhibits IL-6 secretion. Cells were incubated with or without IL-1β (10 U/ml) for 6 hours in the presence of different concentration of IRAK1/4 inhibitor I (1250, 2500, or 5000 nM). IL-6 levels (pg/ml) in the culture supernatants were determined by ELISA. Shown are mean levels +/− S.D. of three replicate stimulations.

This indicates that inhibition of IRAK1/4 could reduce the neuroinflammatory response in Alzheimer patients.

1. A method for measuring protein kinase activity in a cerebrospinal fluid, said method comprising the steps of:
a) obtaining a sample of cerebrospinal fluid;
b) incubating said sample with ATP on an array of substrates; and,
c) obtaining a detectable phosphorylation profile, said profile resulting from the interaction of the cerebrospinal fluid sample with the array of substrates.

2. The method according to claim 1, wherein said substrates are substrates for protein kinases.

3. The method according to claim 1, wherein said substrates are peptide substrates for protein kinases.

4. The method according to claim 1, wherein said substrates are at least two peptide substrates for protein kinases chosen from the group consisting of the substrates for protein kinases with SEQ ID NO: 1 to 140.

5. The method according to claim 1, wherein said substrates are at least two peptide substrates for protein kinases chosen from the group consisting of the peptides with any of SEQ ID NO: 80, 29, 9, 107, 108, 79, 55, 24, 19, 31, 120, 36, 6, 57, 95, 99, 116, 34, 12, 22, 129, 32, 18, 106, 47, 132, 71, 38, 125, 127, 117, 62, 15, 51, 128, 103, 8, 139, 83, 5, 94, 45, 87 and 52.

6. The method according to claim 1, wherein said array is a flow-through array.

7. The method according to claim 1, further comprising a step wherein the phosphorylation profile obtained in step (c) is compared to a set of sample profiles of known neurological and psychiatric pathologies to ascertain the particular pathology of the cerebrospinal fluid being analysed.

8. The method according to claim 7, wherein the pathology is selected from the group comprising neurological and/or psychiatric disorders, such as Alzheimer's disease, Huntington's disease, Parkinson's disease, Creutzfeldt-Jakob disease and other prion diseases, fronto temporal dementia, dystonia, ataxia's, schizophrenia, epilepsy, depression, brain tumors, brain irradiation, head trauma, multiple sclerosis, white matter disorders, metabolic disorders, acute and chronic encephalitic and vascular disease.

9. An array of substrates comprising peptides selected from the group of peptide substrates for protein kinases consisting of the substrates for protein kinases with SEQ ID NO: 1 to 140.

10. A diagnostic kit using a method according to claim 1.

11. A phosphorylation profile obtained using a method according to claim 1.

12. The phosphorylation profile according to claim 11, wherein said phosphorylation profile is specific for a certain neurological and/or psychiatric pathology.

13. The phosphorylation profile according to claim 11, wherein said phosphorylation profile can be used for the classification, diagnosis, prognosis and/or monitoring disease progression of neurological and psychiatric disorders as well as the prediction and monitoring of treatment effects of said neurological and psychiatric disorders.

14. The method according to claim 1 for the classification, diagnosis, prognosis and/or monitoring of neurological and psychiatric disorders as well as the prediction and monitoring of treatment effects of said neurological and psychiatric disorders.

15. The method according to claim 1 for drug discovery and/or screening.

16. The phosphorylation profile according to claim 11 for the classification, diagnosis, prognosis and/or monitoring of neurological and psychiatric disorders as well as the prediction and monitoring of treatment effects of said neurological and psychiatric disorders.

17. The phosphorylation profile according to claim 11 for drug discovery and/or screening.
